(19) United States
(12) Patent Application Publication
(10) Pub. No.: US 2026/0254778 A1
(43) Pub. Date: Aug. 27, 2026

(54) OUT-OF-BAND ETHERNET INTERFACE SWITCHING APPARATUS, MULTI-NODE SERVER SYSTEM AND SERVER DEVICE

(71) Applicant: SUZHOU METABRAIN INTELLIGENT TECHNOLOGY CO., LTD., Suzhou, Jiangsu (CN)

(72) Inventor: Bin YANG, Suzhou, Jiangsu (CN)

(21) Appl. No.: 18/876,942

(22) PCT Filed: Dec. 25, 2023
(86) PCT No.: PCT/CN2023/141645

§ 371 Date: Dec. 19, 2024

(30) Foreign Application Priority Data
Mar. 9, 2023 (CN) 202310219482.9

(51) Int. Cl. H04L 49/351; H04L 49/111; H04L 49/15

(52) U.S. Cl. CPC H04L 49/351; H04L 49/111; H04L 49/15

(57) ABSTRACT

An out-of-band Ethernet interface switching apparatus, a multi-node server system, and a server device are provided by the present application. In the present application, the out-of-band management switch may be directly connected via one cable, thereby the quantity of ports of the out-of-band management switch is released, the hardware resource utilization of the server system is improved, the quantity of cables required for connection is reduced and the operation and maintenance cost of the system are helped to be reduced.

### CROSS-REFERENCE TO RELATED APPLICATION

This application claims the priority of the Chinese Patent application filed on Mar. 9, 2023 before the China National Intellectual Property Administration with the application number of 202310219482.9, and the title of “OUT-OF-BAND ETHERNET INTERFACE SWITCHING APPARATUS, MULTI-NODE SERVER SYSTEM AND SERVER DEVICE”, which is incorporated herein in its entirety by reference.

### FIELD

The present application relates to the technical field of computer hardware design and, more particularly, to an out-of-band Ethernet interface switching apparatus, a multi-node server system, and a server device.

### BACKGROUND

With the rapid development of an electronic technology, the forms of server products are constantly being innovated from a conventional architectural server to a later blade server, and now to a more common multi-node server. In the process of updating the forms of the server products, different degrees of optimization and upgrading of the original forms and architecture of the server products at each stage are achieved, thus the function of a server system is promoted to be better exerted.

Network management of the server is usually divided into two management modes: in-band management and out-of-band management. The in-band management refers to transmitting network management control information and user data service information via the same link. The out-of-band management refers to transmitting network management control information and user data service information via different links, which are independent of each other and do not affect each other. Equivalently, the out-of-band management provides special bandwidth for the network management control information without occupying original network resources of a device and relying on an own operating system and communication interfaces of the device, thus the reliability of information transmission may be effectively improved.

Generally, each computing node in a multi-node server system includes a central processing unit (CPU) subsystem and a baseboard manager controller (BMC) subsystem. The BMC subsystem is server management software that runs independently from an x86 side and is often used for out-of-band management. However, because a plurality of computing nodes have a plurality of BMC subsystems, each BMC subsystem needs to be connected to a port of an out-of-band management switch via a cable in the manner of realizing out-of-band management. Therefore, the plurality of BMC subsystems correspondingly need to be connected to a plurality of ports of the out-of-band management switch via a plurality of cables, thereby leading to a large number of ports of the out-of-band management switch occupied in the connection process, which is not conducive to the utilization of system hardware resources, and a large number of cables used for connection, which results in cumbersome connection, low connection efficiency, and high operation and maintenance cost of the system.

### SUMMARY

In view of this, an out-of-band Ethernet interface switching apparatus, a multi-node server system and a server device are provided in the present application to at least solve the problems that a large number of ports of an out-of-band management switch occupied in out-of-band management of an existing server system is not conducive to the utilization of system hardware resources and a large number of cables results in high operation and maintenance cost of the system.

In order to achieve the above object, the technical solutions of the present application are realized as follows.

In a first aspect, an out-of-band Ethernet interface switching apparatus applied to a multi-node server system is provided by the present application, wherein the multi-node server system includes at least two computing nodes, and each of the at least two computing nodes includes a central processing unit (CPU) subsystem and a baseboard manager controller (BMC) subsystem;
the out-of-band Ethernet interface switching apparatus includes a first switching chip, and the first switching chip has a first switch interface and at least two communication interfaces;
the first switch interface is configured to be connected to an out-of-band management switch, and the at least two communication interfaces are configured to be connected to BMC subsystems, wherein each of the at least two communication interfaces is connected to one of the BMC subsystems; and
a first out-of-band channel is formed from each of the BMC subsystems to the out-of-band Ethernet interface switching apparatus and the out-of-band management switch for a remote user to access out-of-band information of the each of the BMC subsystems.

In some embodiments, the at least two communication interfaces include at least one first communication interface; and
one of the at least one first communication interface is configured to be connected to one of the BMC subsystems, and performs information transmission between the first switching chip and the BMC subsystem with a first mode signal.

In some embodiments, the out-of-band Ethernet interface switching apparatus further includes a second switching chip, the at least two communication interfaces further include at least one second communication interface;
one of the at least one second communication interface is configured to be connected to one of the BMC subsystems via the second switching chip, and performs information transmission between the first switching chip and the second switching chip with a second mode signal; and
the second switching chip is configured to convert the second mode signal sent by the one of at least one second communication interface into the first mode signal and send the first mode signal to the BMC subsystem, and convert the first mode signal sent by the BMC subsystem into the second mode signal and send the second mode signal to the one of the at least one second communication interface.

In some embodiments, a quantity of the second switching chip is equal to a quantity of the at least one second communication interface, one of the at least one second communication interface is connected to one second switching chip, and one second switching chip is connected to one of the BMC subsystems.

In some embodiments, the out-of-band Ethernet interface switching apparatus further includes first type connectors;
the at least one first communication interface and the second switching chip are connected to the BMC subsystems via the first type connectors, respectively.

In some embodiments, the first switching chip further includes a register configuration module, and the register configuration module is configured to:
configure a register corresponding to the at least one first communication interface into a first interface mode to cause the at least one first communication interface to send or receive the first mode signal; and
configure a register corresponding to the at least one second communication interface into a second interface mode to cause the at least one second communication interface to send or receive the second mode signal.

In some embodiments, the first switching chip further includes a memory; and
the register configuration module is connected to the memory, and the register configuration module is configured to obtain configuration information from the memory, and configure the at least one first communication interface into the first interface mode and the at least one second communication interface into the second interface mode according to the configuration information.

In some embodiments, the first interface mode is a reduced gigabit media independent interface (RGMII) mode and the second interface mode is a serial gigabit media independent interface (SGMII) mode.

In some embodiments, the out-of-band Ethernet interface switching apparatus further includes a second type connector;
the first switch interface is connected to the out-of-band management switch via the second type connector.

In some embodiments, the first switch interface is a media dependent interface (MDI), and the second type connector is an RJ45 connector; or, the first switch interface is a square connector (SC) interface, and the second type connector is an SC type optical fiber connector.

In some embodiments, an isolation transformer is connected in series to the first switch interface, and the isolation transformer is configured to protect the first switching chip.

In some embodiments, the first switching chip further has a third communication interface, and the third communication interface is configured to be connected to a smart network card.

In some embodiments, there is a media access control (MAC) address list in the first switching chip and the out-of-band information has a destination address; and
the first switching chip is configured to match the destination address of the out-of-band information with the MAC address list to determine a target MAC address corresponding to the destination address, and then to send the out-of-band information to an interface corresponding to the target MAC address.

In some embodiments, the out-of-band Ethernet interface switching apparatus further includes a voltage regulating module;
the voltage regulating module is configured to regulate an operating voltage of the out-of-band Ethernet interface switching apparatus to maintain voltage stability of the out-of-band Ethernet interface switching apparatus.

In some embodiments, the out-of-band Ethernet interface switching apparatus further includes a clock module;
the clock module is configured to generate a clock signal to synchronize a task action of the out-of-band Ethernet interface switching apparatus.

In a second aspect, a multi-node server system is further provided by the present application, the multi-node server system includes at least two computing nodes and the out-of-band Ethernet interface switching apparatus according to any one of embodiments stated above;
each of the at least two computing nodes includes the CPU subsystem and the BMC subsystem, the CPU subsystem is configured to process in-band information, and the BMC subsystem is configured to process out-of-band information; and
each of the BMC subsystems is connected to one of the at least two communication interfaces of the out-of-band Ethernet interface switching apparatus.

In some embodiments, the multi-node server system further includes a smart network card and an in-band management switch;
the smart network card is connected to the CPU subsystem, the smart network card has a second switch interface, and the second switch interface is connected to the in-band management switch; and
an in-band channel is formed from the CPU subsystem to the smart network card and the in-band management switch for a remote user to access the in-band information.

In some embodiments, the smart network card has a network controller sideband interface (NCSI), and the smart network card is connected to the out-of-band Ethernet interface switching apparatus via the NCSI; and
a second out-of-band channel is formed from each of the BMC subsystems to the out-of-band Ethernet interface switching apparatus, the smart network card and the in-band management switch for a remote user to access the out-of-band information.

In some embodiments, the multi-node server system further includes input output (IO) units, and each of the IO units is connected to one of the at least two computing nodes.

In some embodiments, the multi-node server system further includes a power supply module, the power supply module is connected to the at least two computing nodes and is configured to supply power to the at least two computing nodes.

In some embodiments, the multi-node server system further includes a heat dissipation module, the heat dissipation module is connected to the at least two computing nodes and is configured to dissipate heat from the at least two computing nodes.

In a third aspect, a server device is further provided, the server device includes the multi-node server system according to any one of embodiments stated above.

Compared with the related art, the out-of-band Ethernet interface switching apparatus, the multi-node server system, and the server device of the present application have the following advantages.

The out-of-band Ethernet interface switching apparatus of the present application is equivalent to a common out-of-band Ethernet interface unit, which may identify media access control (MAC) addresses of BMC subsystems in a plurality of computing nodes and establish connections between the out-of-band Ethernet interface switching apparatus and the BMC subsystems. Then, a connection between the out-of-band Ethernet interface switching apparatus and the out-of-band management switch is directly established via a cable. The connection process only occupies one port of the out-of-band management switch to form a first out-of-band channel. Compared with a conventional connection manner, the quantity of ports of the out-of-band management switch is released, the hardware resource utilization of the server system is effectively improved, and the quantity of cables required for connection is reduced, so that the connection manner is simplified, the connection efficiency is improved, and the operation and maintenance cost of the system are helped to be reduced.

The multi-node server system and the server device of the present application have the same or similar advantages as the above out-of-band Ethernet interface switching apparatus compared with the related art, which are not discussed herein further.

### BRIEF DESCRIPTION OF THE DRAWINGS

The drawings, constituting a part of the present application, serve to provide a further understanding of the present application, and schematic embodiments of the present application and the specification thereof serve to explain the present application and are not to be construed as unduly limiting the present application.

FIG. 1 is a schematic diagram of an out-of-band Ethernet interface switching apparatus in the present application;

FIG. 2 is a schematic diagram of another out-of-band Ethernet interface switching apparatus in the present application;

FIG. 3 is a schematic diagram of an out-of-band Ethernet interface switching apparatus including specific switching chips in the present application; and

FIG. 4 is a schematic diagram of a multi-node server system in the present application.

### DETAILED DESCRIPTION

The technical solutions in the embodiments of the present application will be clearly and completely described below with reference to the drawings in the embodiments of the present application. It is obvious that the described embodiments are only a part of the embodiments of the present application, rather than all the embodiments. All other embodiments obtained by a person skilled in the art based on the embodiments of the present application without making creative efforts fall within the protection scope of the present application.

“First”, “second”, and other terms in the specification and claims of the present application are used for distinguishing between similar objects and not necessarily used for describing a particular order or sequential order. It should be understood that such data used may be interchangeable where appropriate so that embodiments of the present application may be implemented in an order other than those illustrated or described herein, and that objects distinguished by “first”, “second”, etc. belong generally to one class, and the quantity of objects is not limited. For example, the quantity of the first object may be one or plural. Furthermore, “and/or” in the specification and claims represents at least one of the connected objects, and the character “/” generally represents that the associated objects are in an “or” relationship.

It should be understood that “an embodiment” throughout the specification means that a particular feature, structure, or characteristic related to the embodiment is included in at least one embodiment of the present application. Therefore, the appearance of “in an embodiment” throughout the specification does not necessarily refer to the same embodiment. Furthermore, these particular features, structures, or characteristics may be incorporated in any suitable manner in one or more embodiments.

Hereinafter, an out-of-band Ethernet interface switching apparatus and a multi-node server system provided by the present application are described in detail by enumerating specific embodiments.

Referring to FIG. 1, the out-of-band Ethernet interface switching apparatus provided by the embodiments of the present application is applied to a multi-node server system. The multi-node server system includes at least two computing nodes. Each of the at least two computing nodes includes a central processing unit (CPU) subsystem and a baseboard manager controller (BMC) subsystem. The out-of-band Ethernet interface switching apparatus includes a first switching chip. The first switching chip has a first switch interface and at least two communication interfaces. The first switch interface is configured to be connected to an out-of-band management switch, and the at least two communication interfaces are configured to be connected to the BMC subsystems. Each of the at least two communication interfaces is connected to one of the BMC subsystems. A first out-of-band channel is formed from each of the BMC subsystems to the out-of-band Ethernet interface switching apparatus and the out-of-band management switch for a remote user to access out-of-band information of the each of the BMC subsystem.

In the present application, the multi-node server system is composed of a plurality of computing nodes and a management unit of the entire management apparatus. The computing nodes are a core part of the server system, mainly complete the functions of data computing, storage, input, and output, and ensure the normal running of the server system. The plurality of computing nodes are physically and logically independent of each other. When one of the computing nodes fails, the normal operation of the other computing nodes will not be affected. Each computing node has a module management portion for switching an action mode of the computing node. The module management portion switches an action of each computing node alone or in coordination with other computing nodes according to information transferred from the management unit.

Each computing node includes a CPU subsystem and a BMC subsystem. As a core component of a server, the CPU subsystem is mainly configured to process instructions, execute operations, control time, process data, etc. to realize the basic calculation and task processing functions of the server system. The BMC subsystem is mainly configured to monitor the temperature, voltage, and other health statuses of a CPU, a memory, a hard disk, a fan, and other components of the server, and also to adjust the running statuses of the components in real time according to a monitoring situation to ensure the normal running of the system. It should be noted that the BMC subsystem is an independent system that does not depend on other hardware on the system, but may interact with a basic input output system (BIOS) and an operating system (OS) to play a better platform management role. Each BMC subsystem in the present application has an independent media access control (MAC) address. The MAC address is written inside the hardware and is an address for confirming a location of a network device. Since the address is unique, each BMC subsystem has an independent MAC address. By the identification and matching of the MAC address, the BMC subsystem may collect management control information of a network to realize out-of-band management.

As shown in FIG. 1, the out-of-band Ethernet interface switching apparatus includes a first switching chip. The first switching chip may be a Marvell 88E6321 chip, a Marvell 88E6320 chip, or the like. The specific type is not limited in the present application. The first switching chip has a first switch interface and at least two communication interfaces. The first switch interface is configured to be connected to an out-of-band management switch. The switch is a network device for forwarding an electrical signal or an optical signal, may provide an exclusive signal path for any two network nodes accessing the switch, and may complete the function of encapsulating and forwarding data information based on MAC address identification. The out-of-band management switch is an out of band (OOB) switch. The OOB switch is mainly configured to transmit management control information and may form an independent network that is not associated with any data forwarding network. When there is a problem with the data forwarding network, the network of the OOB switch is not affected, and a device may still be accessed via the OOB switch. Generally, the OOB switch has 12 to 48 ports, which have small data transmission volume. The transmission rate of 1 Gbit/s may meet the needs. By default, a remote user may access the BMC subsystems of the plurality of computing nodes at the same time via different IP addresses to obtain out-of-band information and realize the access and processing of the out-of-band information. The out-of-band information refers to the management control information of the network. The communication interface is configured to identify the MAC address of the BMC subsystem and establish a connection. Each communication interface is connected to one MAC address. That is, each communication interface is connected to one BMC subsystem. After the communication interface establishes a connection to the BMC subsystem and the first switch interface establishes a connection to the out-of-band management switch, a first out-of-band channel may be formed from each BMC subsystem to the out-of-band Ethernet interface switching apparatus and the out-of-band management switch for the remote user to access out-of-band information of the BMC subsystem.

In the design of the conventional multi-node server system, the BMC subsystems of the plurality of computing nodes need to be connected to a plurality of ports of the out-of-band management switch via a plurality of cables to realize the transfer of the out-of-band information. Exemplarily, if the server system includes four computing nodes, the four computing nodes include four BMC subsystems, and the four BMC subsystems ultimately need to be connected to four ports of the out-of-band management switch via four cables. That is, the connection process needs to occupy four ports of the out-of-band management switch in total, and at least four cables need to be configured. In this connection manner, a large number of ports of the out-of-band management switch are occupied, which easily leads to tight connection of other electronic components, and reduces the utilization of hardware resources of the server system. In addition, a large number of cables for connection are needed, which results in cumbersome connection, low connection efficiency, and high operation and maintenance cost of the system. The server system of the present embodiment is additionally provided with an out-of-band Ethernet interface switching apparatus. The out-of-band Ethernet interface switching apparatus of the present application is equivalent to a common out-of-band Ethernet interface unit, which may identify MAC addresses of BMC subsystems in a plurality of computing nodes and establish a connections between the out-of-band Ethernet interface switching apparatus and the BMC subsystems. Then, a connection between the out-of-band Ethernet interface switching apparatus and the out-of-band management switch may be directly established via a cable. The connection process only occupies one port of the out-of-band management switch to form a first out-of-band channel for the remote user to access and process the out-of-band information. Exemplarily, if the server system includes four computing nodes and the four computing nodes include four BMC subsystems in total, the four communication interfaces of the out-of-band Ethernet interface switching apparatus may identify the four MAC addresses and establish a connection, thereby the connection between the out-of-band Ethernet interface switching apparatus and the BMC subsystems is realized. After the connection, the out-of-band Ethernet interface switching apparatus is connected to one port of the out-of-band management switch via a cable to form a first out-of-band channel. In the connection process, a total of one port of the out-of-band management switch is occupied, and only one cable is needed to be configured for connection to the out-of-band management switch. Compared with the conventional connection manner, three ports of the out-of-band management switch are released, locations are provided for connection of other electronic components, the hardware resource utilization of the server system is effectively improved, and the quantity of cables required for connection is reduced from four to one, so that the connection method is simplified, the connection efficiency is improved, and the operation and maintenance cost of the system is helped to be reduced.

In conclusion, the out-of-band Ethernet interface switching apparatus of the present application is equivalent to a common out-of-band Ethernet interface unit, which may identify MAC addresses of BMC subsystems in a plurality of computing nodes and establish connections between the out-of-band Ethernet interface switching apparatus and the BMC subsystems. Then, a connection between the out-of-band Ethernet interface switching apparatus and the out-of-band management switch is directly established via a cable. The connection process only occupies one port of the out-of-band management switch to form a first out-of-band channel. Compared with a conventional connection manner, the quantity of ports of the out-of-band management switch is released, the hardware resource utilization of the server system is effectively improved, and the quantity of cables required for connection is reduced, so that the connection manner is simplified, the connection efficiency is improved, and the operation and maintenance cost of the system are helped to be reduced.

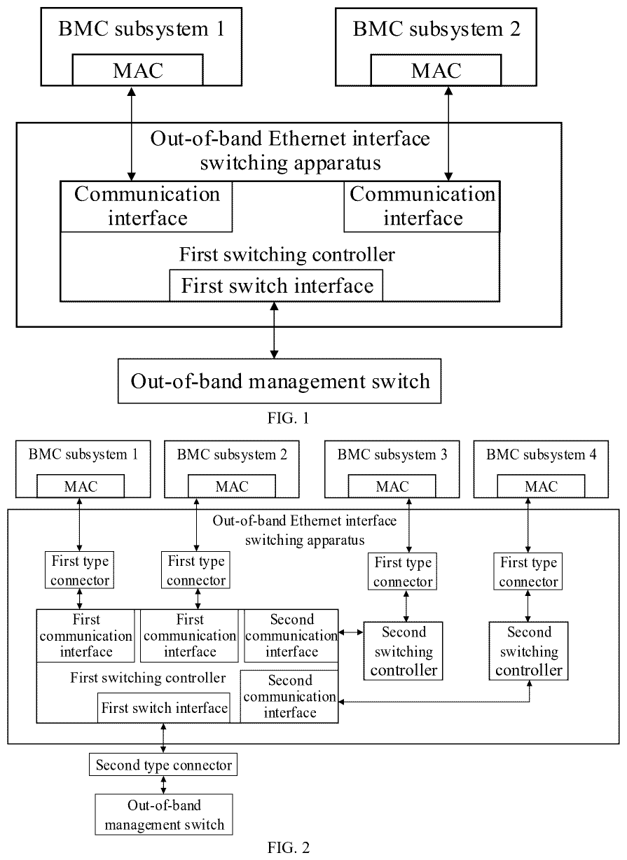

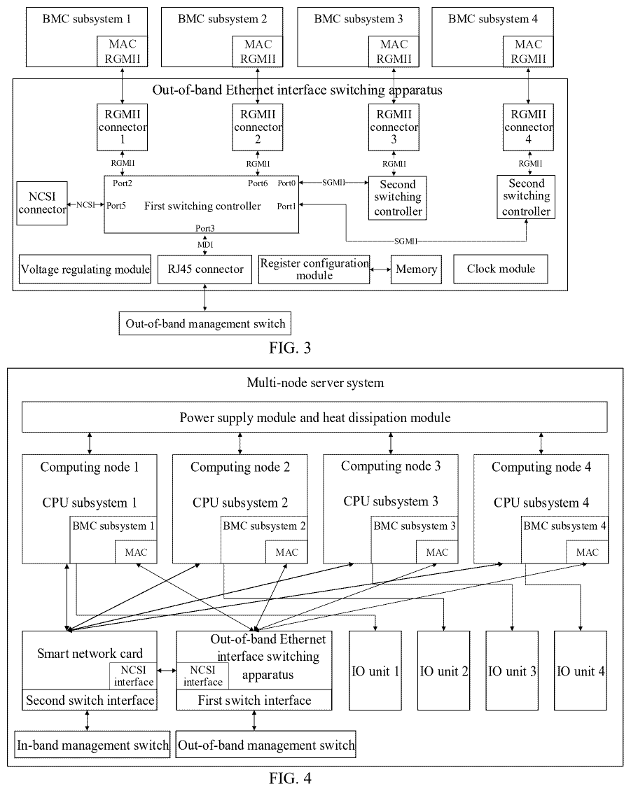

In some embodiments, referring to FIG. 2 and FIG. 3, the at least two communication interfaces include at least one first communication interface. One of the at least one first communication interface is configured to be connected to one of BMC subsystems, and performs information transmission between the first switching chip and the BMC subsystem with a first mode signal.

In the present application, referring to FIG. 2, the at least two communication interfaces in the first switching chip include at least one first communication interface. The first communication interfaces are configured to be connected to the BMC subsystems, and one first communication interface is configured to be connected to one BMC subsystem. After the connection, the first communication interface performs information transmission between the first switching chip and the BMC subsystem with a first mode signal. As shown in FIG. 3, the first switching chip is, for example, a Marvell 88E6321 chip. The Marvell 88E6321 chip is a 7-Port gigabit Ethernet switching chip. Seven pins include Port 0 to Port 6. Port 0 and Port 1 are optical port pins, which may perform conversion between optical signals and electrical signals, and may support transmission rates of 100 M and gigabit. Port 2, Port 5, and Port 6 are communication pins, may be configured into an MAC mode or a PHY mode, and all support a media independent interface (MII) mode, a reduced MII (RMII), and a reduced gigabit MII (RGMII) mode. Port 3 and Port 4 are Ethernet pins and may support 10 M, 100 M, and gigabit adaptive Ethernet connections. The first communication interface in the present application refers to Port 2 and Port 6. The Marvell 88E6321 chip is connected to the BMC subsystem of the computing node via Port 2 and Port 6, and is correspondingly connected to the two BMC subsystems of the two computing nodes. After Port 2 and Port 6 are connected to the BMC subsystem, Port 2 and Port 6 will send or receive a first mode signal, thereby information transmission is performed between the Marvell 88E6321 chip and the BMC subsystem with the first mode signal. In some embodiments, Port 2 and Port 6 may be configured in an RGMII mode, thereby information transmission is performed between the Marvell 88E6321 chip and the BMC subsystem with an RGMII mode signal. The RGMII mode adopts a four-bit data interface, data is sampled on both the rising edge and the falling edge for transmission, and a gigabit transmission rate may be kept. The quantity of interface signal lines is small, so that the quantity of connecting cables and connecting ports may be greatly reduced, the connection manner is simplified, and the operation and maintenance connection costs are reduced.

In some embodiments, referring to FIG. 2 and FIG. 3, the out-of-band Ethernet interface switching apparatus further includes a second switching chip. The at least two communication interfaces further include at least one second communication interface. One of the at least one second communication interface is configured to be connected to one of the BMC subsystems via the second switching chip, and performs information transmission between the first switching chip and the second switching chip with a second mode signal. The second switching chip is configured to convert the second mode signal sent by the one of the at least one second communication interface into the first mode signal and send the first mode signal to the BMC subsystem, and convert the first mode signal sent by the BMC subsystem into the second mode signal and send the second mode signal to the one of the at least one second communication interface.

In the present application, as shown in FIG. 2, the out-of-band Ethernet interface switching apparatus further includes a second switching chip. The at least two communication interfaces further include at least one second communication interface. The at least one second communication interface is configured to be connected to the BMC subsystems via the second switching chip. One of the at least one second communication interface is connected to one second switching chip, and one second switching chip is connected to one BMC subsystem. The second switching chip is configured to convert the second mode signal sent by the one of at least one second communication interface into the first mode signal and send the first mode signal to the BMC subsystem, and convert the first mode signal sent by the BMC subsystem into the second mode signal and send the second mode signal to the one of at least one second communication interface. After the second communication interface is connected to the second switching chip, the second communication interface performs information transmission between the first switching chip and the second switching chip with a second mode signal.

As shown in FIG. 3, for the Marvell 88E6321 chip, the second communication interface in the present application refers to Port 0 and Port 1. The Marvell 88E6321 chip is connected to the second switching chip via Port 0 and Port 1, and two second switching chips are correspondingly connected. After Port 0 and Port 1 are connected to the second switching chip, Port 0 and Port 1 will send or receive a second mode signal, thereby information transmission is performed between the Marvell 88E6321 chip and the second switching chip with the second mode signal. The second switching chip may convert the first mode signal to the second mode signal or convert the second mode signal to the first mode signal, thereby information transmission is performed between the second switching chip and the BMC subsystem with the first mode signal. At the same time, since one second switching chip is connected to one BMC subsystem, two second switching chips are correspondingly connected to two BMC subsystems. On the basis that the Marvell 88E6321 chip is connected to the two BMC subsystems via Port 2 and Port 6, in the present embodiment, the connection of four BMC subsystems may be realized at the same time, thereby transferring out-of-band information to and from the four BMC subsystems simultaneously.

In an embodiment, a Marvell 88E1512 chip is adopted as the second switching chip. The Marvell 88E1512 chip is a single-port gigabit Ethernet transceiver. A voltage regulator is integrated inside the chip, and the chip supports operating voltages of 1.8 V, 2.5 V, and 3.3 V, which may meet the operating requirements of most electronic components. Moreover, a digital-analog mixed signal processing technology is adopted by the chip, equalization, echo, crosstalk cancellation, data recovery, and error correction at gigabit rate may be achieved, performance standards are high and power consumption is low, and system operating costs may be effectively saved. It should be emphasized that the Marvell 88E1512 chip may realize an RGMII with automatic media detection, a serial GMII (SGMII), and mutual conversion between the RGMII and the SGMII. In combination with the above embodiments, in the present application, Port 0 and Port 1 of the Marvell 88E6321 chip may be configured into the SGMII mode, so that information is transferred between the Marvell 88E6321 chip and the Marvell 88E1512 chip with the SGMII mode signal. The Marvell 88E1512 chip may realize mutual conversion between the RGMII mode and the SGMII mode, and the information is finally transferred between the Marvell 88E1512 chip and the BMC subsystem with the RGMII mode signal after the conversion.

In some embodiments, referring to FIG. 2 and FIG. 3, the out-of-band Ethernet interface switching apparatus further includes first type connectors. The at least one first communication interface and the second switching chip are connected to the BMC subsystems via the first type connectors, respectively.

In the present application, the first type connector needs to have the function of transmitting the first mode signal. In combination with the above embodiments, if the first mode signal is the RGMII mode signal, an RGMII connector is correspondingly adopted as the first type connector. The specific connection manner is shown in FIG. 3. The two RGMII connectors are connected to Port 2 and Port 6 of the Marvell 88E6321 chip. The two RGMII connectors are connected to the two Marvell 88E1512 chips in one-to-one correspondence. Each RGMII connector is connected to the BMC subsystem of the computing node. Through the RGMII connector, the smooth and reliable signal transmission may be ensured, the flexibility of the connection process may be improved, and the connection manner may be simplified.

In some embodiments, referring to FIG. 3, the first switching chip further includes a register configuration module. The register configuration module is configured to: configure a register corresponding to the one of the at least one first communication interface into a first interface mode to cause the one of the at least one first communication interface to send or receive the first mode signal; and configure a register corresponding to the one of the at least one second communication interface into a second interface mode to cause the one of the at least one second communication interface to send or receive the second mode signal.

In the present application, the register configuration module may configure a register corresponding to the first communication interface of the first switching chip into a first interface mode. In the first interface mode, the first communication interface may send or receive the first mode signal. The register configuration module may also configure a register corresponding to the second communication interface into a second interface mode. In the second interface mode, the second communication interface may send or receive the second mode signal. Taking that the first switching chip is a Marvell 88E6321 chip as an example, an RGMII operating mode may be configured by setting a Px_MODE pin level, and an SGMII operating mode may be configured by setting a Px_SMODE pin level. For example, for Port 2 and Port 6, a pin is in an input state when being reset. In this state, a pin level may be set to determine an operating mode of the pin. After the pin level is set, a reset signal will latch the pin level during the rising edge, so that the pin enters the corresponding operating mode. During the setting of the pin level, if the levels of Port 2 and Port 6 are pulled up, the default operating mode is an RGMII mode. For other modes, a resistor may be directly connected in series to ground on the hardware for configuration, which will not be described in detail in the present application.

In combination with the foregoing embodiments, the first interface mode is the RGMII mode and the second interface mode is the SGMII mode. Therefore, in the present application, the first communication interfaces Port 2 and Port 6 are configured into the RGMII mode by setting the Px_MODE pin level. That is, the first interface mode is the RGMII mode, and an RGMII mode signal may be sent or received. The second communication interfaces Port 0 and Port 1 are configured into the SGMII mode by setting the Px_SMODE pin level. That is, the second interface mode is the SGMII mode, and an SGMII mode signal may be sent or received.

In some embodiments, referring to FIG. 3, the first switching chip further includes a memory. The register configuration module is connected to the memory. The register configuration module is configured to obtain configuration information from the memory, and configure the first communication interface into the first interface mode and the second communication interface into the second interface mode according to the configuration information.

In the present application, the memory is a memory component for storing programs and various data information, including a read only memory (ROM) and a random access memory (RAM). The ROM is read-only during the execution of the programs, and is usually configured to store fixed programs, constants, etc. The RAM is readable and writable during the execution of the programs, and an access time is not related to a physical location of a storage unit. In the present application, the memory connected to the register configuration module is the ROM. In a preferred implementation, the memory is an electrically erasable programmable read only memory (EEPROM). The EEPROM is a storage chip that does not lose data after power failure, and may erase existing information on a computer or a special device and perform reprogramming for a user to modify server data. The register configuration module is configured to obtain configuration information from the EEPROM. The configuration information includes mode information of each pin of the first switching chip, so that the first communication interface may be configured into the first interface mode and the second communication interface may be configured into the second interface mode according to the configuration information.

In some embodiments, referring to FIG. 2 and FIG. 3, the out-of-band Ethernet interface switching apparatus further includes a second type connector. The first switch interface is connected to the out-of-band management switch via the second type connector.

In the present application, the switches may be connected via a network cable or an optical fiber. Therefore, the second type connector is a network cable connector or an optical fiber connector. The first switch interface of the first switching chip may be connected to the out-of-band management switch via the second type connector. The network cable connector is resistant to shock, vibration and electromagnetic interference, has high flexibility, and may realize connection by plugging and unplugging. The connection process does not require the aid of tools, which is easy for personnel to operate. The network cable connector may support both a high-power device and a low-power device. However, due to the distance limitation, long-distance transmission is prone to signal attenuation and even results in signal interruption. The optical fiber connector precisely connects two end surfaces of the optical fiber, so that optical energy outputted by a transmitting optical fiber may be coupled to a receiving optical fiber to the maximum extent. The optical fiber connector has high transmission signal rate and low attenuation, which may allow a longer transmission distance. The optical fiber connector especially supports the high-power device. However, the cost of the optical fiber connector is high, bending parts are easily damaged, and the maintenance cost is high. A person skilled in the art may reasonably select the connection manner of the first switch interface according to actual needs, which is not limited in the present application.

In some embodiments, referring to FIG. 3, the first switch interface is a media dependent interface (MDI), and the second type connector is an RJ45 connector. Alternatively, the first switch interface is a square connector (SC) interface, and the second type connector is an SC type optical fiber connector.

In the present application, in the manner that network cable connection is adopted by the switch, the first switch interface of the first switching chip may be configured into an MDI mode via the register configuration module. The second type connector is preferably an RJ45connector. That is, the first switch interface is connected to the out-of-band management switch via the RJ45 connector. The RJ45 connector has the characteristics of low cost, convenient wiring, convenient plugging and unplugging, etc. The hard-wired connection provided by the connector allows higher data speed, may ensure the stability of the signal transmission process, and may improve the security of the signal transmission process. When Ethernet is a 100 M network, the MDI uses four wires and two pairs of differential signals for data transmission. When Ethernet is a gigabit network, the MDI uses eight wires and four pairs of differential signals for data transmission. The RJ45 connector is connected to the first switch interface of the first switching chip and the out-of-band management switch, so that a first out-of-band channel is formed from the BMC subsystem to the out-of-band Ethernet interface switching apparatus, the RJ45 connector and the out-of-band management switch for a remote user to access out-of-band information.

When the manner of the optical fiber connection is adopted by the switch, the first switch interface of the first switching chip may be configured into an SC interface mode via the register configuration module. The second type connector is an SC type optical fiber connector. That is, the first switch interface is connected to the out-of-band management switch via the SC type optical fiber connector. A housing of the SC type optical fiber connector is rectangular, and the SC type optical fiber connector is fastened by pin plugging and pulling. The fastening process does not require rotation. The SC type optical fiber connector has a low price, a convenient plug-and-pull operation, a small loss fluctuation in the access process, a high compressive strength, and a high installation density. The SC type optical fiber connector is connected to the first switch interface of the first switching chip and the out-of-band management switch, so that a first out-of-band channel is formed from the BMC subsystem to the out-of-band Ethernet interface switching apparatus, the SC type optical fiber connector and the out-of-band management switch for a remote user to access out-of-band information.

In some embodiments, an isolation transformer is connected in series to the first switch interface, and the isolation transformer is configured to protect the first switching chip.

In the present application, since the out-of-band management switch is connected to an external circuit and the instability risk or security risk of the external circuit is relatively large, an isolation transformer is connected in series to the first switch interface of the first switching chip. The isolation transformer may enhance the signal and realize the isolation between the first switching chip and the external circuit, thereby greatly enhancing the anti-interference ability of the first switching chip and playing a better protection role for the first switching chip.

In some embodiments, referring to FIG. 3, the first switching chip further has a third communication interface, and the third communication interface is configured to be connected to a smart network card.

In the present application, the first switching chip further has a third communication interface. As shown in FIG. 3, the third communication interface is a network controller sideband interface (NCSI). The smart network card may be connected via the NCSI. In combination with the above embodiments, taking that the first switching chip is a Marvell 88E6321 chip as an example, Port 5 of the Marvell 88E6321 chip may be configured into an NCSI mode via the register configuration module, thereby the connection between the Marvell 88E6321 chip and the smart network card is realized through Port 5. The smart network card is a Smart NIC, the core of the Smart NIC is to assist the CPU in processing network load via a field programmable gate array, balance the load and remove other low-level functions from the CPU, thus the load of the CPU may be greatly reduced. At the same time, the out-of-band Ethernet interface switching apparatus is connected to the smart network card, the transfer path of out-of-band information may be enriched, and the transfer of the out-of-band information via the in-band channel between the smart network card and the CPU subsystem is realized.

In some embodiments, there is an MAC address list in the first switching chip, and the out-of-band information has a destination address. The first switching chip is configured to match the destination address of the out-of-band information with the MAC address list to determine a target MAC address corresponding to the destination address, and then to send the out-of-band information to an interface corresponding to the target MAC address.

In the present application, the first switching chip receives out-of-band information sent by an out-of-band switch via the first switch interface. The out-of-band information includes a plurality of data packets. Each data packet has a respective destination address. There is an MAC address list in the first switching chip. Each MAC address in the MAC address list corresponds to one interface of the switch, namely the first communication interface, the second communication interface, the third communication interface, or the like in the foregoing embodiments. Generally, the destination address of each data packet in the out-of-band information corresponds to one MAC address in the MAC address list. The first switching chip matches the destination address of the out-of-band information with the MAC address list in the first switching chip to determine the MAC address corresponding to each data packet, namely a target MAC address. After determining the target MAC address of each data packet, the first switching chip may send the data packet to an interface corresponding to the target MAC address, thereby the classified transfer of the out-of-band information is realized. At the same time, in the first switching chip, the conversion of an analog signal of the out-of-band information to a digital signal of the RGMII mode, the SGMII mode or the NCSI mode may be completed, and then the digital signal is sent to the corresponding interface, thereby the out-of-band information is transmitted to different interfaces in different modes.

In some embodiments, referring to FIG. 3, the out-of-band Ethernet interface switching apparatus further includes a voltage regulating module. The voltage regulating module is configured to regulate an operating voltage of the out-of-band Ethernet interface switching apparatus to maintain voltage stability of the out-of-band Ethernet interface switching apparatus.

In the present application, the voltage regulating module may regulate the operating voltage of each electronic component in the out-of-band Ethernet interface switching apparatus, including the first switching chip, the second switching chip, and the like, so that the voltage change thereof does not exceed a prescribed range. Therefore, the voltage stability of the out-of-band Ethernet interface switching apparatus may be maintained, and the use security of various electronic components may be ensured. Moreover, by using the voltage regulating module, the operating requirements of different CPUs in the server system may be met, the complexity of manual intervention is reduced, and the difficulty of system design is reduced.

In some embodiments, referring to FIG. 3, the out-of-band Ethernet interface switching apparatus further includes a clock module. The clock module is configured to generate a clock signal to synchronize a task action of the out-of-band Ethernet interface switching apparatus.

In the present application, the clock module is configured to generate a clock signal, and each electronic component in the out-of-band Ethernet interface switching apparatus will sequentially perform task actions along with the clock signal generated by the clock module, thereby reliability and accuracy of task processing is improved and normal operation of each electronic component is ensured.

Referring to FIG. 4, a multi-node server system is further provided by an embodiment of the present application, the multi-node server system includes at least two computing nodes and the out-of-band Ethernet interface switching apparatus according to any one of the embodiments stated above. Each computing node includes a CPU subsystem and a BMC subsystem, the CPU subsystem is configured to process in-band information, and the BMC subsystem is configured to process out-of-band information. Each BMC subsystem is connected to one of the at least two communication interfaces of the out-of-band Ethernet interface switching apparatus.

In the present application, with the popularization of new generation information technologies represented by cloud computing, artificial intelligence, big data, mobile Internet, and Internet of Things, data centers are exhibiting explosive expansion, and the problems of data center occupation and power consumption have become major problems on the development path of the industry. When designing, building and operating large data centers, the data centers are developing towards a high-density mode. Under this background, multi-node servers are increasingly favored by users because of their characteristics such as high density, high scalability, high availability, and high manageability. The multi-node server system includes at least two computing nodes and the out-of-band Ethernet interface switching apparatus according to the embodiments stated above. Each computing node includes a CPU subsystem and a BMC subsystem, and the CPU subsystem is configured to process in-band information. Since the present application provides a dedicated out-of-band Ethernet interface switching apparatus to form a dedicated out-of-band channel to transfer network management control information, the in-band information of the present embodiment mainly refers to user data service information. The CPU subsystem is mainly configured to process user data service information, the BMC subsystem is mainly configured to process network management control information, and the BMC subsystem of each computing node has an independent MAC address. The identification and matching of the MAC address will establish a connection with a communication interface of the out-of-band Ethernet interface switching apparatus to realize the transfer of out-of-band information.

In some embodiments, referring to FIG. 4, the multi-node server system further includes a smart network card and an in-band management switch. The smart network card is connected to the CPU subsystem. The smart network card has a second switch interface. The second switch interface is connected to the in-band management switch. An in-band channel is formed from the CPU subsystem to the smart network card and the in-band management switch for a remote user to access the in-band information.

In the present application, due to the increasing demand for a high-performance server system, different services have different requirements for the server system. In the field of artificial intelligence computing, a large amount of data will be inputted from the network, and in order to ensure smooth reception of data, the application of a smart network card in the server system is becoming more and more popular. The smart network card may be used for directly performing necessary processing on the data, thereby the load of the CPU is greatly reduced. The multi-node server system of the present embodiment further includes a smart network card. The smart network card is connected to the CPU subsystem, and the smart network card further has a second switch interface. An in-band management switch may be connected via the second switch interface. The in-band management switch is connected to the smart network card, and the in-band management switch is mainly configured to transmit user data service information with large data transmission amount. Generally, a transmission rate of about 10 Gbit/s is needed. The smart network card is connected to the in-band management switch and the CPU subsystem respectively, so that an in-band channel may be formed from the CPU subsystem to the smart network card and the in-band management switch for a remote user to access the in-band information.

In some embodiments, the smart network card is connected to the CPU subsystem via a peripheral component interconnect express (PCIE) bus. The PCIE bus belongs to high-speed serial point-to-point dual-channel high-bandwidth transmission. The connected smart network card and CPU subsystem allocate exclusive channel bandwidth without sharing bus bandwidth. The data transmission rate is high, which may ensure data fluency of in-band data information transmission and avoid data delay. Also, the PCIE bus has higher bus throughput, lower number of IO pins and more detailed error detection and reporting mechanism, which may effectively reduce the complexity of communication connection between the smart network card and the CPU subsystem, and provide more accurate data transmission for the smart network card and the CPU subsystem, thereby the smooth running of the server system is guaranteed.

In some embodiments, referring to FIG. 4, the smart network card has an NCSI. The smart network card is connected to the out-of-band Ethernet interface switching apparatus via the NCSI. A second out-of-band channel is formed from each BMC subsystem to the out-of-band Ethernet interface switching apparatus, the smart network card and the in-band management switch for a remote user to access the out-of-band information.

In the present application, the smart network card has an NCSI. The management of the smart network card by the server system is realized via an NCSI protocol. The smart network card is connected to the out-of-band Ethernet interface switching apparatus via the NCSI. Therefore, a second out-of-band channel may be formed from the BMC subsystem of each computing node to the out-of-band Ethernet interface switching apparatus, the smart network card and the in-band management switch for a remote user to access the out-of-band information. In this environment, the remote user may access the out-of-band information not only via the BMC subsystem, the out-of-band Ethernet interface switching apparatus and the out-of-band management switch, but also via the BMC subsystem, the out-of-band Ethernet interface switching apparatus, the smart network card, and the in-band management switch, thereby the transfer ways of the out-of-band information are enriched and the flexibility of the server system is improved. In addition, the smart network card of the present embodiment includes an open compute project (OCP) network card, a MOC network card, a data processing unit (DPU) network card, and the like, and a person skilled in the art may reasonably select the type of the network card according to the specific design needs of the server system, which is not limited in the present application.

In some embodiments, referring to FIG. 4, the multi-node server system further includes IO units. Each IO unit is connected to one computing node.

In the present application, the IO unit is an industrial-grade remote collection and control module, which provides functions such as switching input collection, relay output, and high-frequency counter of passive nodes, and may be configured for data collection and various control applications. The quantity of IO units is the same as the quantity of computing nodes of the server system. Each IO unit is connected to one computing node to provide data input and output between the computing node and an external circuit. The IO unit of the present embodiment may be any one or a combination of an accelerator card, an inference card, a training card, a video analysis card, a solid-state hard disk, a hybrid hard disk, and a universal serial bus (USB), which is not limited in the present application.

In some embodiments, referring to FIG. 4, the multi-node server system further includes a power supply module. The power supply module is connected to the computing nodes and is configured to supply power to the computing nodes.

In the present application, the power supply module is connected to a plurality of computing nodes, and is mainly configured to supply power to electronic components included in the computing nodes to ensure normal running of the computing nodes. Since voltages required for normal operation of the electronic components may be different, there may be a plurality of power supply modules, so as to realize independent power supply of the electronic components and avoid the failure of the power supply module directly causing crash of the server system. Definitely, a voltage regulating circuit, a voltage stabilizing circuit, or the like may be connected between the power supply module and each electronic component to regulate the output voltage of the power supply module to make the output voltage to be adapted to the required voltage of the electronic components.

In some embodiments, referring to FIG. 4, the multi-node server system further includes a heat dissipation module. The heat dissipation module is connected to the computing nodes and is configured to dissipate heat from the computing nodes.

In the present application, the heat dissipation module is connected to the plurality of computing nodes, and is mainly configured to dissipate heat from the computing nodes during operation to avoid excessive environmental temperature, affecting normal execution of logical operations and other functions of the computing nodes, and causing problems such as running lag of the server system. The heat dissipation module generally includes air-cooled heat dissipation and water-cooled heat dissipation. In the field of servers, the air-cooled heat dissipation technology is more mature, safer to use, and simpler in structure. However, it is easy to generate noise during the heat dissipation process, and compared with the water-cooled heat dissipation, the air-cooled heat dissipation has low heat dissipation efficiency. The heat dissipation effect of the water-cooled heat dissipation is good, and the noise during the heat dissipation is small, but there is a hidden danger of water leakage. If the water leakage occurs, the electronic components are easily short-circuited, and security accidents are even caused. The selection of the heat dissipation manner may be determined according to actual design requirements of the server system, which is not limited in the present application.

A server device is further provided by an embodiment of the present application, including the multi-node server system according to any one of the embodiments stated above.

In the present application, the server device is a core device of the entire network, including the foregoing multi-node server system, and may perform logical operations, respond to service requests, execute corresponding commands, etc. depending on the multi-node server system. In terms of hardware, the server device includes a processor, a BMC, an out-of-band Ethernet interface switching apparatus, a hard disk, a memory, a bus, etc. The server device has an in-band channel and an out-of-band channel, and may relatively independently transfer network management control information and user data business information, thereby more stable, reliable and secure services are provided.

Finally, it should be additionally noted that relational terms such as first and second herein are configured solely to distinguish one entity or operation from another entity or operation without necessarily requiring or implying any such actual relationship or order between such entities or operations. Moreover, the terms “include” and “contain” or any other variations thereof are intended to cover a non-exclusive inclusion, whereby a process, method, article, or terminal device that includes a series of elements includes not only those elements, but also other elements that are not expressly listed, or that are inherent in such a process, method, article, or terminal device. It is not excluded, without more constraints, that additional identical elements exist in the process, method, article, or terminal device including elements defined by a sentence “including a . . . ”.

The above descriptions are merely the preferred embodiments of the present application and are not intended to limit the present application. Any modification, equivalent replacement and improvement within the spirit and principle of the present application should be contained in the protection scope of the present application.

1. An out-of-band Ethernet interface switching apparatus applied to a multi-node server system, wherein the multi-node server system comprises at least two computing nodes, and each of the at least two computing nodes comprises a central processing unit (CPU) subsystem and a baseboard manager controller (BMC) subsystem;
the out-of-band Ethernet interface switching apparatus comprises a first switching controller, and the first switching controller has a first switch interface and at least two communication interfaces;
the first switch interface is configured to be connected to an out-of-band management switch, and the at least two communication interfaces are configured to be connected to BMC subsystems, wherein each of the at least two communication interfaces is connected to one of the BMC subsystems; and
a first out-of-band channel is formed from each of the BMC subsystems to the out-of-band Ethernet interface switching apparatus and the out-of-band management switch for a remote user to access out-of-band information of the each of the BMC subsystems.

2. The out-of-band Ethernet interface switching apparatus according to claim 1, wherein the at least two communication interfaces comprise at least one first communication interface; and
one of the at least one first communication interface is configured to be connected to one of the BMC subsystems, and performs information transmission between the first switching controller and the BMC subsystem with a first mode signal.

3. The out-of-band Ethernet interface switching apparatus according to claim 2, wherein the out-of-band Ethernet interface switching apparatus further comprises a second switching controller, the at least two communication interfaces further comprise at least one second communication interface;
one of the at least one second communication interface is configured to be connected to one of the BMC subsystems via the second switching controller, and performs information transmission between the first switching controller and the second switching controller with a second mode signal; and
the second switching controller is configured to convert the second mode signal sent by the one of the at least one second communication interface into the first mode signal and send the first mode signal to the BMC subsystem, and convert the first mode signal sent by the BMC subsystem into the second mode signal and send the second mode signal to the one of the at least one second communication interface.

4. The out-of-band Ethernet interface switching apparatus according to claim 3, wherein a quantity of the second switching controller is equal to a quantity of the at least one second communication interface, one of the at least one second communication interface is connected to one second switching controller, and one second switching controller is connected to one of the BMC subsystems.

5. The out-of-band Ethernet interface switching apparatus according to claim 3, wherein the out-of-band Ethernet interface switching apparatus further comprises first type connectors;
the at least one first communication interface and the second switching controller are connected to the BMC subsystems via the first type connectors, respectively.

6. The out-of-band Ethernet interface switching apparatus according to claim 3, wherein the first switching controller further comprises a register configuration module, and the register configuration module is configured to:
configure a register corresponding to the one of the at least one first communication interface into a first interface mode to cause the one of the at least one first communication interface to send or receive the first mode signal; and
configure a register corresponding to the one of the at least one second communication interface into a second interface mode to cause the one of the at least one second communication interface to send or receive the second mode signal.

7. The out-of-band Ethernet interface switching apparatus according to claim 6, wherein the first switching controller further comprises a memory; and
the register configuration module is connected to the memory, and the register configuration module is configured to obtain configuration information from the memory, and configure the at least one first communication interface into the first interface mode and the at least one second communication interface into the second interface mode according to the configuration information.

8. The out-of-band Ethernet interface switching apparatus according to claim 6, wherein the first interface mode is a reduced gigabit media independent interface (RGMII) mode and the second interface mode is a serial gigabit media independent interface (SGMII) mode.

9. The out-of-band Ethernet interface switching apparatus according to claim 1, wherein the out-of-band Ethernet interface switching apparatus further comprises a second type connector;
the first switch interface is connected to the out-of-band management switch via the second type connector.

10. The out-of-band Ethernet interface switching apparatus according to claim 9, wherein the first switch interface is a media dependent interface (MDI), and the second type connector is an RJ45 connector; or, the first switch interface is a square connector (SC) interface, and the second type connector is an SC type optical fiber connector.

11. The out-of-band Ethernet interface switching apparatus according to claim 9, wherein an isolation transformer is connected in series to the first switch interface, and the isolation transformer is configured to protect the first switching controller.

12. The out-of-band Ethernet interface switching apparatus according to claim 1, wherein the first switching controller further has a third communication interface, and the third communication interface is configured to be connected to a smart network card.

13. The out-of-band Ethernet interface switching apparatus according to claim 1, wherein there is a media access control (MAC) address list in the first switching controller and the out-of-band information has a destination address; and
the first switching controller is configured to match the destination address of the out-of-band information with the MAC address list to determine a target MAC address corresponding to the destination address, and then to send the out-of-band information to an interface corresponding to the target MAC address.

14. The out-of-band Ethernet interface switching apparatus according to claim 1, wherein the out-of-band Ethernet interface switching apparatus further comprises a voltage regulating module;
the voltage regulating module is configured to regulate an operating voltage of the out-of-band Ethernet interface switching apparatus to maintain voltage stability of the out-of-band Ethernet interface switching apparatus.

15. The out-of-band Ethernet interface switching apparatus according to claim 1, wherein the out-of-band Ethernet interface switching apparatus further comprises a clock module;
the clock module is configured to generate a clock signal to synchronize a task action of the out-of-band Ethernet interface switching apparatus.

16. A multi-node server system, comprising the at least two computing nodes and the out-of-band Ethernet interface switching apparatus according to claim 1;
each of the at least two computing nodes comprises the CPU subsystem and the BMC subsystem, the CPU subsystem is configured to process in-band information, and the BMC subsystem is configured to process out-of-band information; and
each of the BMC subsystems is connected to one of the at least two communication interfaces of the out-of-band Ethernet interface switching apparatus.

17. The multi-node server system according to claim 16, wherein the multi-node server system further comprises a smart network card and an in-band management switch;
the smart network card is connected to the CPU subsystem, the smart network card has a second switch interface, and the second switch interface is connected to the in-band management switch; and
an in-band channel is formed from the CPU subsystem to the smart network card and the in-band management switch for a remote user to access the in-band information.

18. The multi-node server system according to claim 17, wherein the smart network card has a network controller sideband interface (NCSI), and the smart network card is connected to the out-of-band Ethernet interface switching apparatus via the NCSI; and
a second out-of-band channel is formed from each of the BMC subsystems to the out-of-band Ethernet interface switching apparatus, the smart network card and the in-band management switch for a remote user to access the out-of-band information.

19. The multi-node server system according to claim 16, wherein the multi-node server system further comprises input output (IO) units, and each of the IO units is connected to one of the at least two computing nodes.

20-21. (canceled)

22. A server device, comprising the multi-node server system according to claims 16.
